(19) United States
(12) Patent Application Publication
(10) Pub. No.: US 2011/0185845 A1
(43) Pub. Date: Aug. 4, 2011

(54) REDUCTION UNIT PARTICULARLY OF THE EPICYCLIC TYPE COMPRISING A FAN

(76) Inventor: Gian Paolo Manzini, Reggio Emilia (IT)

(21) Appl. No.: 12/733,722

(22) PCT Filed: Sep. 11, 2008
(86) PCT No.: PCT/EP2008/062024

§ 371 Date: Mar. 17, 2010

(30) Foreign Application Priority Data
Sep. 19, 2007 (IT) BO2007A000634

(51) Int. Cl. F16H 57/00

(52) U.S. Cl. 74/640

(57) ABSTRACT

A reduction unit, particularly of the epicyclic type, comprising a casing for the rotary support and containment of an input shaft, of an output shaft, and of at least one reduction stage that is interposed between them, the input shaft being able to rotate by an actuation shaft of a motor, which can be associated monolithically and coaxially with the input shaft. The reduction unit comprises at least one fan, which is arranged substantially coaxially to the input shaft, proximate to the reduction unit, and is supported even indirectly by one of the shafts.

The present invention relates to a reduction unit particularly of the epicyclic type.

### BACKGROUND OF THE INVENTION

Currently, many types of reduction unit are commercially available and they all have the same method of operation: be they with parallel axes, with a worm screw, epicyclic, or of other types, each one comprises in fact a casing for the rotary support and containment of an input shaft and of an output shaft; one or more reduction stages are interposed between such shafts in order to bring the rotation rate, transferred in input to the input shaft by a motor that is associated therewith, to a reduced value for the output shaft.

For coupling between the reduction unit and such motor, if the latter is fitted by means of a flange, manufacturers indeed provide a series of flanges, each one specific for a motor type/size, which provide the connection between the motor casing and the casing of the reduction unit. For the coupling of the two shafts, the shaft of the motor and the input shaft of the reduction unit, an ordinary flexible coupling is used typically and indeed joins the motor shaft and the input shaft of the reduction unit and allows to compensate for any misalignments between the motor and the reduction unit.

Among the various existing types of reduction unit, it is straightforward to note the ever-increasing success achieved by epicyclic reduction units, a particular type characterized by the capacity to transmit high torques and power levels despite having small space occupation dimensions and weight, if compared with the other categories of reduction unit, particularly those with parallel axes and with worm screws.

The small space occupation, which is an undisputed bonus for a variety of situations in application, at the same time leads to a weakness if these products have to be used for installations in which the so-called “heat capacity” of the reduction unit is particularly important. The expression “heat capacity” is used to reference the capacity to transmit externally, in the form of heat, the power that is dissipated internally due to the various frictions, without exceeding the temperature level that is deemed acceptable for the reduction unit as a whole.

This is a characteristic that is tightly linked to the dimensions of the outer surfaces of the reduction unit, and it is thus straightforward to note that the reduced dimensions of the epicyclic reduction unit (which are usually appreciated in many other applications) and therefore the limited extent of the outer surface of the reduction unit lead in this case to a limitation rather than an advantage.

In order to obviate this drawback, one known solution, used for parallel and perpendicular reduction units, is to provide the reduction unit with a fan, whose installation, due to the simultaneous presence of the flexible coupling, is possible however only if the overall space occupation of the device is increased significantly.

This is therefore a solution that entails a significant increase in the space occupation of the reduction unit, further affecting the overall cost, in view of the structural complexity.

### SUMMARY OF THE INVENTION

The aim of the present invention is to solve the above-mentioned drawbacks, by providing a reduction unit in which the use of a fan allows in any case to maintain the characteristics of limited space occupation and structural simplicity of said reduction unit and of its coupling to the motor that actuates it.

Within this aim, an object of the invention is to provide a reduction unit that ensures high reliability in operation.

Another object of the invention is to provide a reduction unit that can be obtained easily starting from commonly commercially available elements and materials.

Another object of the invention is to provide a reduction unit that has low costs, is relatively simple to provide in practice and is safe in application.

This aim and these and other objects, which will become better apparent hereinafter, are achieved by a reduction unit, particularly of the epicyclic type, which comprises a casing for the rotary support and containment of an input shaft, of an output shaft, and of at least one reduction stage that is interposed between them, said input shaft being able to rotate by means of an actuation shaft of a motor, which can be associated monolithically and coaxially with said input shaft, characterized in that it comprises at least one fan, which is arranged substantially coaxially to said input shaft, proximate to said reduction unit, and is supported even indirectly by one of said shafts.

### BRIEF DESCRIPTION OF THE DRAWINGS

Further characteristics and advantages of the invention will become better apparent from the following detailed description of a preferred but not exclusive embodiment of the reduction unit according to the invention, illustrated by way of non-limiting example in the accompanying drawings, wherein:

FIG. 1 is a schematic partially sectional side elevation view, taken along an axial plane, of the reduction unit according to the invention, in a first embodiment;

FIG. 2 is a schematic partially sectional side elevation view, taken along an axial plane, of the device according to the invention, in a second embodiment.

### DESCRIPTION OF THE PREFERRED EMBODIMENTS

With reference to the figures, a reduction unit according to the invention, generally designated by the reference numeral 1, comprises, in a first embodiment, of the coaxial epicyclic type, a casing 2 for supporting rotatably and containing an input shaft 3, which is connected to an output shaft 4 by means of at least one reduction stage 5. The input shaft 3 is turned by an actuation shaft 6 of a motor 7, which can be associated monolithically and coaxially with the input shaft 3.

According to the invention, the reduction unit 1 comprises at least one fan 8, which is arranged coaxially to the input shaft 3 (and to the actuation shaft 6), proximate to the reduction unit 1, in order to cool it; the fan 8 is supported even indirectly by one of the shafts 3, 6.

Advantageously, the reduction unit 1 according to the invention comprises at least one rigid coupling 9, which is substantially axially symmetrical, for the connection of the input shaft 3 of the reduction unit 1 to the actuation shaft 6 of the motor 7.

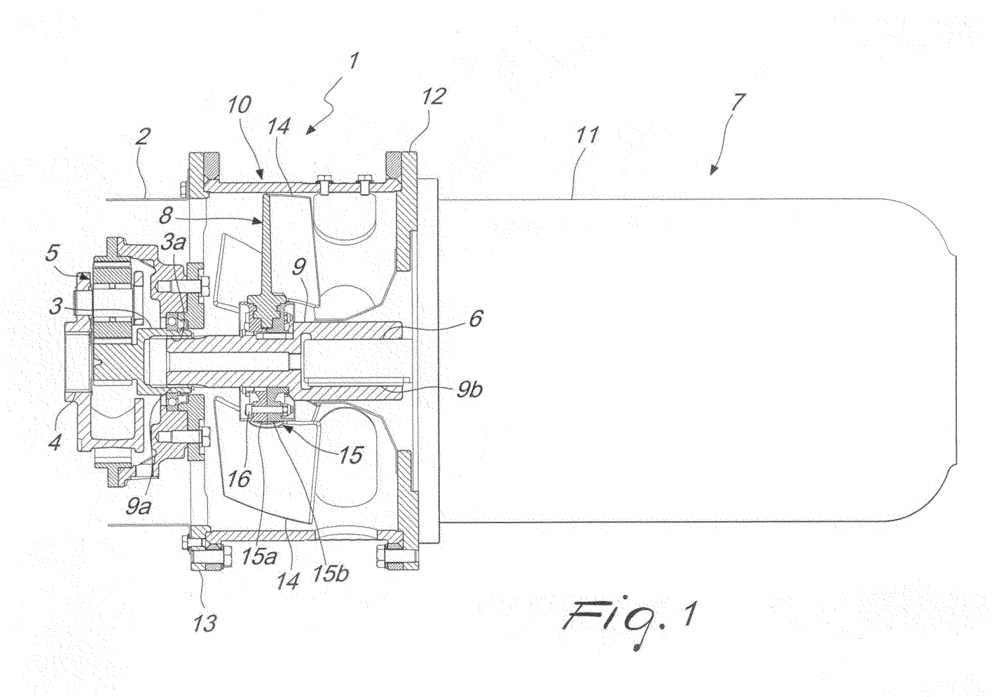

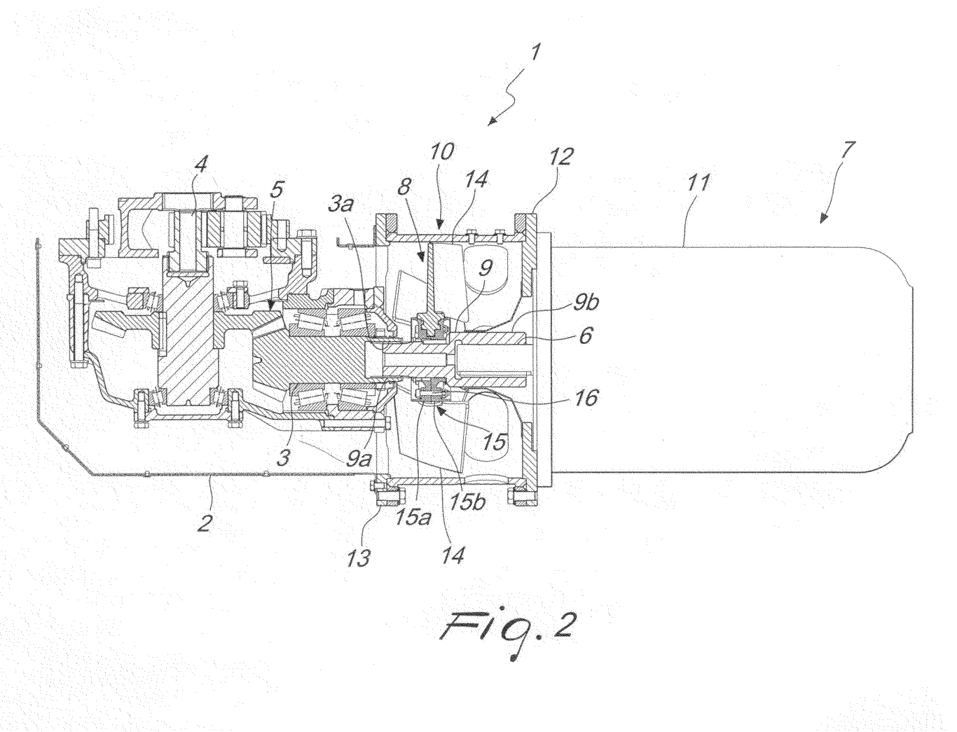

The accompanying figures show, by way of non-limiting example of the application of the reduction unit 1 according to the invention, two possible embodiments: in FIG. 1, the fan 8 is applied to a reduction unit 1 of the coaxial epicyclic type, while in FIG. 2 it is applied to a reduction unit 1 of the epicyclic type with concurrent axes.

In particular, the fan 8 can be jointly supported for moving directly by the input shaft 3 of the reduction unit 1, together with which it can rotate to cool it; the fan 8 is therefore actuated indirectly by the motor 7, thus activating itself usefully automatically during the operation of the reduction unit 1 to reduce the rotation rate of the output shaft 4.

Conveniently, as shown in the accompanying figures, in an alternative embodiment of particular interest in application the fan 8 is instead jointly supported for moving by the rigid coupling 9, and is thus supported indirectly by one of the shafts 3, 6 (which in turn are rigidly coupled to the rigid coupling 9), for example by the input shaft 3, and therefore the fan 8 is again actuated indirectly by the motor 7.

More particularly, the rigid coupling 9 can engage rigidly, in a first end 9a, the end of the input shaft 3 that lies opposite the reduction stage 5, while in the second end 9b it engages rigidly the outer surface of the actuation shaft 6 of the motor 7.

In order to provide the connection, in a first embodiment the first end 9a of the rigid coupling 9 engages rigidly, as shown in the accompanying figures, in a respective seat 3a that is formed inside the input shaft 3, which is of the bell-and-spigot type, while the second end 9b of the rigid coupling 9 is internally hollow in order to engage rigidly the outer surface of the actuation shaft 6 of the motor 7.

In a second embodiment, of the epicyclic type with concurrent axes, the rigid coupling 9 is substantially a sleeve, and the first end 9a and the second end 9b are thus both hollow internally, for rigid coupling respectively to the outer surface of the input shaft 3 and to the outer surface of the actuation shaft 6 of the motor 7.

Advantageously, regardless of the constructive solution chosen for the rigid coupling 9, the reduction unit 1 according to the invention comprises means for lubricating the mutually associated surfaces in order to provide the rigid coupling of the first end 9a of the rigid coupling 9 to the input shaft 3 of the reduction unit 1.

In particular, the lubrication means comprise at least one longitudinal groove, which is formed on at least one of the mutually associated surfaces to feed the lubricating liquid, for example grease, oil or emulsions; the groove can be provided on just one selectively of the two mutually coupled surfaces or on both, arranging them of course so that they face each other; in any case, lubrication is thus made possible without the need to disassemble the various parts involved.

Conveniently, the reduction unit 1 according to the invention comprises at least one substantially tubular box-like body 10 for the connection of the casing 2 of the reduction unit 1 to a case 11 of the motor 7, inside which the fan 8 is accommodated at least partially.

More particularly, the box-like body 10 can be associated, proximate to one of its ends, with a first flange 12 for the connection of the box-like body 10 to the case 11 of the motor 7; the box-like body 10, further, can be coupled jointly for moving, proximate to its other end, to at least one second flange 13, for example by bolting, for connection to the casing 2 of the reduction unit 1.

The modularity that characterizes, as described, the connection of the casing 2 of the reduction unit 1 to the case 11 of the motor 7 allows to reduce, for such connection, the degree of customization to be provided during design and needed to adapt to the variability of the motors 7. The only component that has to vary as a function of the type and size of the case 11 of the motor 7 is in fact the first flange 12, while the second flange 13 and the box-like body 10 are standard, accordingly ensuring the possibility to reduce the number of components to be acquired and kept in store.

Advantageously, the fan 8 comprises a plurality of vanes 14, which are monolithically connected to a hub 15 which can rotate jointly and coaxially with respect to the input shaft 3 of the reduction unit 1 according to the invention; in particular, each vane 14 is connected to the hub 15 by way of means for removable coupling.

More particularly, the hub 15 is constituted by two tubular elements 15a, 15b, which are arranged coaxially, and the means for detachable coupling comprise a plurality of bolts 16, each of which allows the removable fastening of an end portion of one vane 14 between the two mutually facing ends of the two tubular elements 15a, 15b.

In this manner, the fan 8 is substantially modular, in order to contain the costs of the molds and the variety of the various vanes 14 to be kept in stock. Further, the proposed embodiment allows to vary at will the orientation of the vanes 14 during assembly if this is required by the particular type of application.

Differently from the proposed embodiments, it is evident from the provided description of the reduction unit 1 according to the invention (and in particular of the fan 8, of the vanes 14 and of their connection to the hub 15, supported by the input shaft 3 of the reduction unit) that it is in any case possible to provide the fan 8 in a single monolithic block, if particularly substantial sales volumes are expected for the product, such as to justify the corresponding necessary investments.

The operation of the reduction unit 1 according to the invention is evident from what has been described and illustrated, and in particular it is evident that the fan 8 can rotate jointly with the input shaft 3 and with the actuation shaft 6, either because it is keyed directly on the input shaft 3 or because it is supported by the rigid coupling 9, thus cooling the reduction unit 1, during its operation, even without the use of bulkier supports such as flexible couplings, thus ensuring a significant reduction in radial and axial space occupations, at the same time keeping the costs low.

All this is achieved without affecting negatively the performance of the fan 8 (and therefore its capacity to direct a suitable flow of air onto the outer surface of the reduction unit 1) and without detracting anything from the simplicity and the effectiveness of the solution of application of the motor 7 on the reduction unit 1, at the same time ensuring for the latter a low operating temperature, thus allowing to use reduction units 1 of the epicyclic type, which are appreciated, as described earlier, for their advantageous weight-to-power ratio, even where heat capacity is a fundamental requirement.

In practice it has been found that the reduction unit 1 according to the invention fully achieves the proposed aim, since the mounting of the fan 8 coaxially to the input shaft 3 of the reduction unit 1 and to the actuation shaft 6 of the motor 7 allows to avoid resorting to flexible couplings and to additional supporting elements.

The invention thus conceived is susceptible of numerous modifications and variations, all of which are within the scope of the appended claims; all the details may further be replaced with other technically equivalent ones.

In the exemplary embodiments shown, individual characteristics, given in relation to specific examples, may actually be interchanged with other different characteristics that exist in other exemplary embodiments.

Moreover, it is noted that anything found to be already known during the patenting process is understood not to be claimed and to be the subject of a disclaimer.

In practice, the materials used, as well as the dimensions, may be any according to requirements and to the state of the art.

The disclosures in Italian Patent Application No. BO2007A000634 from which this application claims priority are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-10. (canceled)

11. A reduction unit, particularly of the epicyclic type, comprising a casing for the rotary support and containment of an input shaft, of an output shaft, and of at least one reduction stage that is interposed between them, said input shaft being able to rotate by means of an actuation shaft of a motor, which can be associated monolithically and coaxially with said input shaft, further comprising at least one fan, which is arranged substantially coaxially to said input shaft, proximate to said reduction unit, and is supported even indirectly by one of said shafts.

12. The reduction unit according to claim 11, further comprising at least one substantially axially symmetrical rigid coupling for the connection of said input shaft of said reduction unit to the actuation shaft of the motor.

13. The reduction unit according to claim 11, wherein said at least one fan is jointly supported for moving by said input shaft of said reduction unit.

14. The reduction unit according to claim 12, wherein said at least one fan is jointly supported for moving by said rigid coupling, being thus supported indirectly by one of said shafts that are jointly connected for moving to said rigid coupling.

15. The reduction unit according to claim 14, wherein said rigid coupling comprises a first end, which can be engaged rigidly with the end of said input shaft that lies opposite said at least one reduction stage, the second end of said rigid coupling being rigidly engageable with the actuation shaft of the motor.

16. The reduction unit according to claim 15, further comprising means for lubricating mutually associated surfaces, for the coupling of said first end of said rigid coupling to said input shaft, said lubrication means comprising at least one longitudinal groove, which is formed on at least one of the mutually associated surfaces, for feeding lubricating fluid.

17. The reduction unit according to claim 11, further comprising at least one substantially tubular box-like body for the connection of said casing of said reduction unit to a case of the motor, said fan being accommodated at least partially within said box-like body.

18. The reduction unit according to claim 17, wherein said box-like body is jointly associable for moving, proximate to one of its ends, with a first flange to connect said box-like body to the case of the motor, said box-like body being jointly associable for moving, proximate to its other end, with at least one second flange, for the connection of said box-like body to said casing of said reduction unit.

19. The reduction unit according to claim 11, wherein said fan comprises a plurality of vanes, which are jointly connected for moving to a hub that can rotate coaxially to said input shaft of said reduction unit, said fan comprising means for the detachable coupling of each of said vanes to said hub.

20. The reduction unit according to claim 19, wherein said hub is constituted by two coaxially arranged tubular elements, said means for detachable coupling comprising a plurality of bolts, each one of said vanes being lockable, at an end portion thereof, between the two facing ends of said two tubular elements by means of one of said bolts.
